(19) United States
(12) Patent Application Publication
(10) Pub. No.: US 2018/0019553 A1
(43) Pub. Date: Jan. 18, 2018

(54) CONNECTOR

(71) Applicant: FUJITSU COMPONENT LIMITED, Tokyo (JP)

(72) Inventor: Takashi YUBA, Tokyo (JP)

(21) Appl. No.: 15/546,753

(22) PCT Filed: Jan. 13, 2016
(86) PCT No.: PCT/JP2016/050836

§ 371 Date: Jul. 27, 2017

(30) Foreign Application Priority Data
Feb. 6, 2015 (JP) 2015-022619

(51) Int. Cl. H01R 13/707; H01R 24/22; H01R 103/00

(52) U.S. Cl. CPC H01R 13/707; H01R 24/22; H01R 2103/00

(57) ABSTRACT

A connector includes two connection terminals to be electrically connected to terminals of another connector, and a switch connected to the connection terminals. The switch includes a first switch connected to one of the connection terminals, the first switch including a first fixed part including a fixed contact, and a first movable part including a movable contact that is contactable by the fixed contact, and a second switch connected to another of the connection terminals, the second switch including a second fixed part including a fixed contact, and a second movable part including a movable contact that is contactable by the fixed contact. The first fixed part and the second fixed part, or the first movable part and the second movable part include multiple contacts.

### TECHNICAL FIELD

The present invention relates to connectors.

### BACKGROUND ART

In general, electrical apparatuses are supplied with electric power via a connector. The connector used in this case establishes an electrical connection by mating together a male-ended connector having a protruding shape and a female-ended connector having an indented shape.

In recent years, as a measure against global warming, the supply of direct-current high-voltage electric power, which is limited in power loss in voltage conversion or power transmission and does not require an increase in cable thickness, has been studied in power transmission in local areas as well. Such form of supplying electric power is considered desirable particularly for information apparatuses such as servers, which consume large amounts of electric power.

Electric power supplied to electrical apparatuses may affect human bodies or may affect the operations of electronic components if the voltage is high.

In the case of using such high-voltage electric power for information apparatuses, a connector needs to be different from connectors used for ordinary alternate-current commercial power supplies.

### PRIOR ART DOCUMENT

[Patent Document 1] Japanese Laid-open Patent Publication No. 5-82208
[Patent Document 2] Japanese Laid-open Patent Publication No. 2003-31301

### SUMMARY OF THE INVENTION

### Problems to be Solved by the Invention

For a connector into which a switch is incorporated, currently used switches cannot be used as they are when the voltage supplied from a power supply is a direct-current high voltage. For example, when the electric power supplied from a power supply is direct-current 400 V, it is dangerous to use a switch currently used for an alternating current as it is because sufficient safety and reliability are not ensured.

### Means for Solving the Problems

According to an aspect of the present invention, a connector includes two connection terminals to be electrically connected to terminals of another connector, and a switch connected to the connection terminals. The switch includes a first switch connected to one of the connection terminals, the first switch including a first fixed part including a fixed contact, and a first movable part including a movable contact that is contactable by the fixed contact, and a second switch connected to another of the connection terminals, the second switch including a second fixed part including a fixed contact, and a second movable part including a movable contact that is contactable by the fixed contact. The first fixed part and the second fixed part, or the first movable part and the second movable part include multiple contact

### Effects of the Invention

According to an embodiment of the present invention, a connector that supports direct-current power supplies or a power supply of a voltage higher than current commercial power supply voltages and is capable of safely supplying electric power from these power supplies can be provided.

### BRIEF DESCRIPTION OF THE DRAWINGS

FIG. 1 is a perspective view of a plug connector used in a first embodiment.

FIG. 2 is a plan view of the plug connector used in the first embodiment.

FIG. 3 is a side view of the plug connector used in the first embodiment.

FIG. 4 is a bottom view of the plug connector used in the first embodiment.

FIG. 5 is a front view of the plug connector used in the first embodiment.

FIG. 6 is a perspective view of a connector according to the first embodiment.

FIG. 7 is a front view of the connector according to the first embodiment.

FIG. 8 is a side view of the connector according to the first embodiment.

FIG. 9 is an internal structure diagram of the connector according to the first embodiment (off state).

FIG. 10 is a perspective view of a switch according to the first embodiment.

FIG. 11 is a structure diagram of the switch according to the first embodiment (off state).

FIG. 12 is a structure diagram of the switch according to the first embodiment (on state).

FIG. 13 is a diagram illustrating the connector and the plug connector before connection according to the first embodiment.

FIG. 14 is a diagram illustrating an off state after the connection of the connector and the plug connector according to the first embodiment.

FIG. 15 is a diagram illustrating an on state after the connection of the connector and the plug connector according to the first embodiment.

FIG. 16 is an internal structure diagram of the connector according to the first embodiment (on state).

FIG. 17 is a structure diagram of a switch of a connector.

FIG. 18 is a diagram illustrating the switch of the connector.

FIG. 19 is a structure diagram of a twin-contact switch of the connector according to the first embodiment.

FIG. 20 is a perspective view of the twin-contact switch of the connector according to the first embodiment.

FIG. 21 is a diagram illustrating the twin-contact switch of the connector according to the first embodiment.

FIG. 22 is a plan view of the twin-contact switch of the connector according to the first embodiment.

FIG. 23 is a diagram illustrating the switch of the connector.

FIG. 24 is a diagram illustrating the switch of the connector.

FIG. 25 is a diagram illustrating the twin-contact switch of the connector according to the first embodiment.

FIG. 26 is a diagram illustrating the twin-contact switch of the connector according to the first embodiment.

FIG. 27 is a diagram illustrating the twin-contact switch of the connector according to the first embodiment.

FIG. 28 is a diagram illustrating the twin-contact switch of the connector according to the first embodiment.

FIG. 29 is a diagram illustrating the twin-contact switch of the connector according to the first embodiment.

FIG. 30 is a diagram illustrating the twin-contact switch of the connector according to the first embodiment.

FIG. 31 is a diagram illustrating the twin-contact switch of the connector according to the first embodiment.

FIG. 32 is a diagram illustrating the twin-contact switch of the connector according to the first embodiment.

FIG. 33 is a structure diagram of a twin-contact switch of a connector according to a second embodiment.

FIG. 34 is a perspective view of the twin-contact switch of the connector according to the second embodiment.

FIG. 35 is a plan view of the twin-contact switch of the connector according to the second embodiment.

### MODES FOR CARRYING OUT THE INVENTION

Embodiments of the present invention are described below. The same members are given the same reference numeral, and a description thereof will be omitted. Furthermore, according to the embodiments, high voltage does not mean “750 V DC or higher” defined in the Electrical Equipment Technical Standards or “1500 V DC or higher” internationally defined by the International Electrotechnical Commission (IEC), but means voltages in excess of the safety extra-low voltage (below 60 V DC).

### First Embodiment

### (Connector Structure)

A connector according to a first embodiment is described.

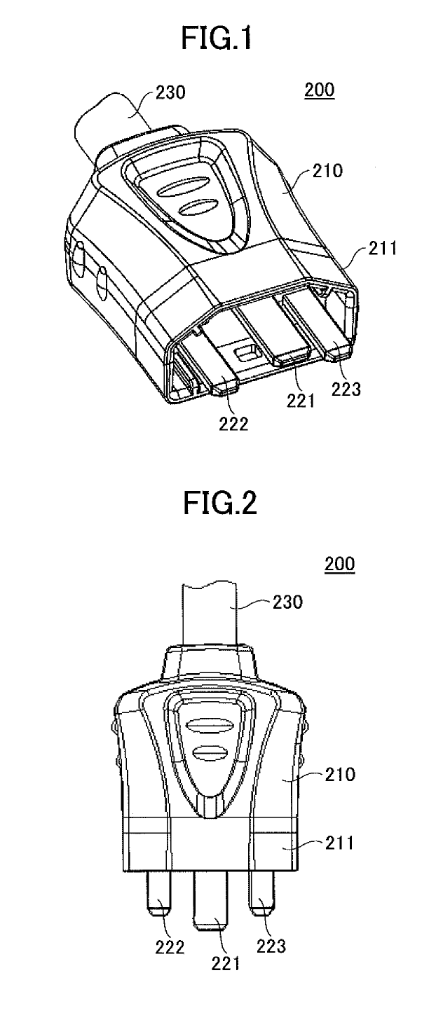

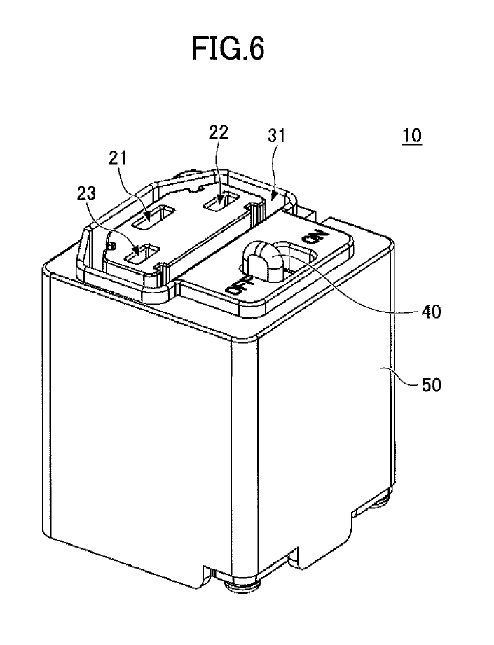

A connector 10 according to this embodiment is depicted in FIGS. 6 through 8, and is configured to be connected to a plug connector 200 depicted in FIGS. 1 through 5.

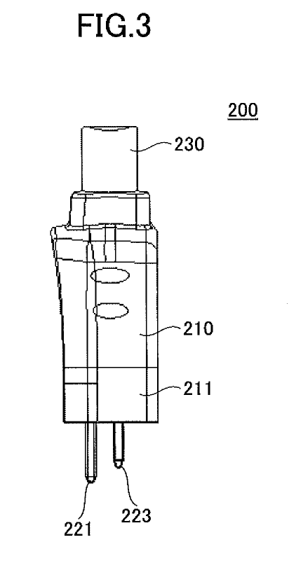

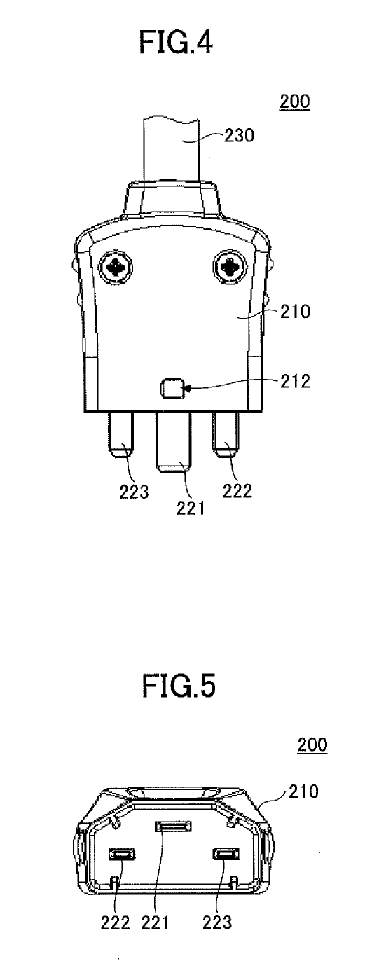

The plug connector 200 is described based on FIGS. 1 through 5. FIG. 1 is a perspective view, FIG. 2 is a plan view, FIG. 3 is a side view, FIG. 4 is a bottom view, and FIG. 5 is a front view of the plug connector 200.

The plug connector 200 includes a cover 210 formed of an insulator and three plug terminals 221, 222 and 223. A power supply cable 230 is connected to the cover 210 on the side opposite from the side on which the plug terminals 221, 222 and 223 are provided. The plug terminal 221 is a GND terminal, and is formed to be longer than the plug terminals 222 and 223. The plug terminals 222 and 223 are terminals configured to be electrically connected to terminals of the connector 10 to be supplied with electric power. The cover 210 of the plug connector 200 is provided with a protection part 211 formed to partially cover the plug terminals 221, 222 and 223. Furthermore, an opening 212 for preventing the plug connector 200 from being disconnected from the connector 10 is provided in the cover 210.

Next, the connector 10 according to this embodiment is described based on FIGS. 6 through 8.

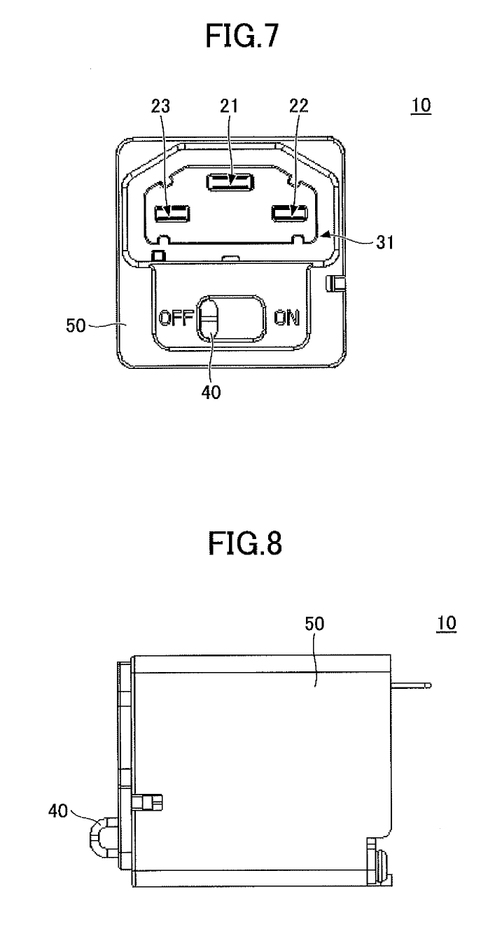

FIG. 6 is a perspective view, FIG. 7 is a front view, and FIG. 8 is a side view of the connector 10. The connector 10 includes a covering housing 50, and is provided with jack openings 21, 22 and 23 for inserting the plug terminals 221, 222 and 223, respectively, of the plug connector 200, a groove 31 for inserting the protection part 211 of the plug connector 200, and a slide 40 for switching the supply of electric power in the state where the plug 35. connector 200 and the connector 10 are connected. The slide 40 is slidable to the “ON” position or “OFF” position. The supply of electric power via the connector 10 can be switched by sliding the slide 40.

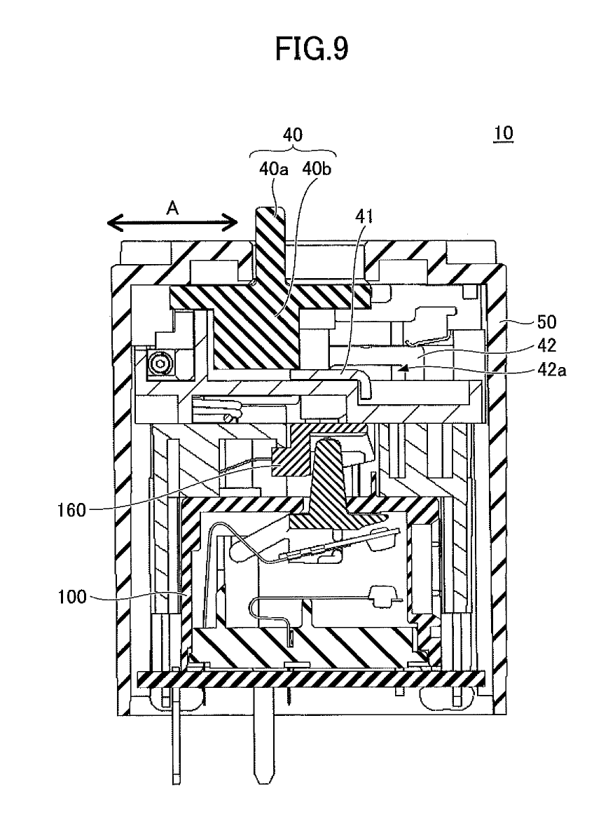

An internal structure of the connector 10 is described based on FIG. 9. FIG. 9 is a cross-sectional view of the connector 10. The connector 10 has an operation part 40a, which is part of the slide 40, projecting outward through an opening provided in the housing 50. A switch 100 provided in the housing 50 can be operated by moving the operation part 40a in the directions of the arrow A from outside the housing 50.

The slide 40 includes a slide body 40b positioned in the housing 50, and the slide body 40b is connected to a slide link 41.

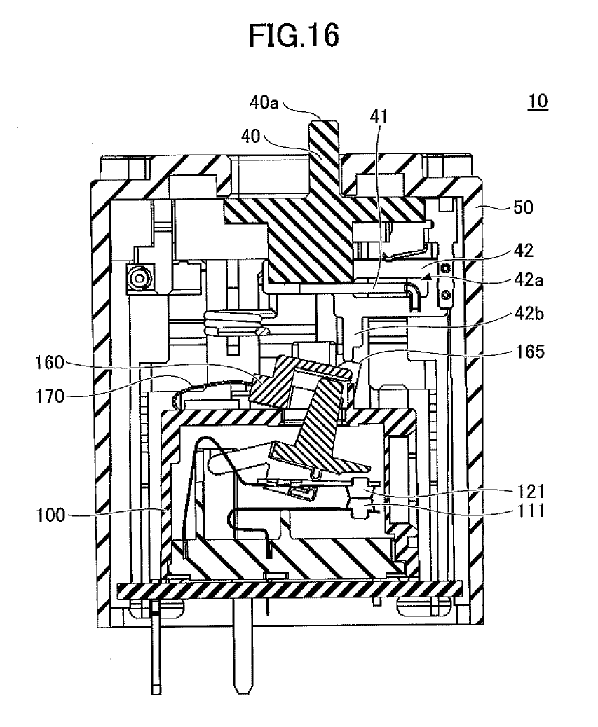

The slide link 41 moves substantially parallel to the sliding directions indicated by the arrow A with the movements of the slide 40, and is formed in an L shape. One end of the slide link 41 is in an opening 42a of a contact slide 42. As described below, by moving the slide 40 in the rightward direction of the arrow A, the contact slide 42 depresses a button 160. The opening 42a is formed in a shape elongated along the directions of movement, namely, sliding directions, of the slide link 41. Furthermore, the contact slide 42 is provided with a contact part 42b (depicted in FIG. 16) that extends substantially vertically downward relative to the sliding directions. An end of the contact part 42b contacts an upper surface of the button 160 of the switch 100.

### (Switch)

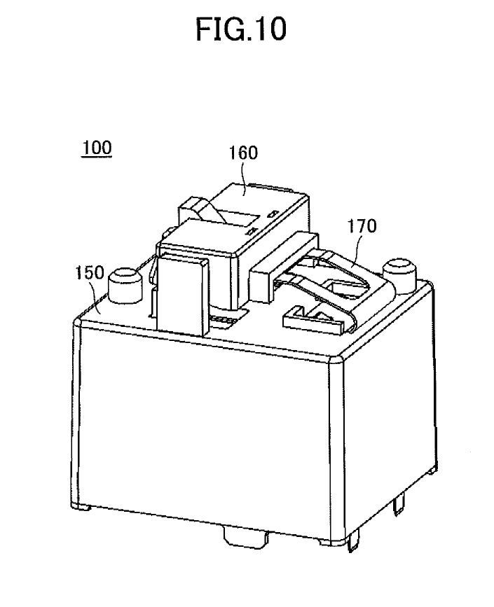

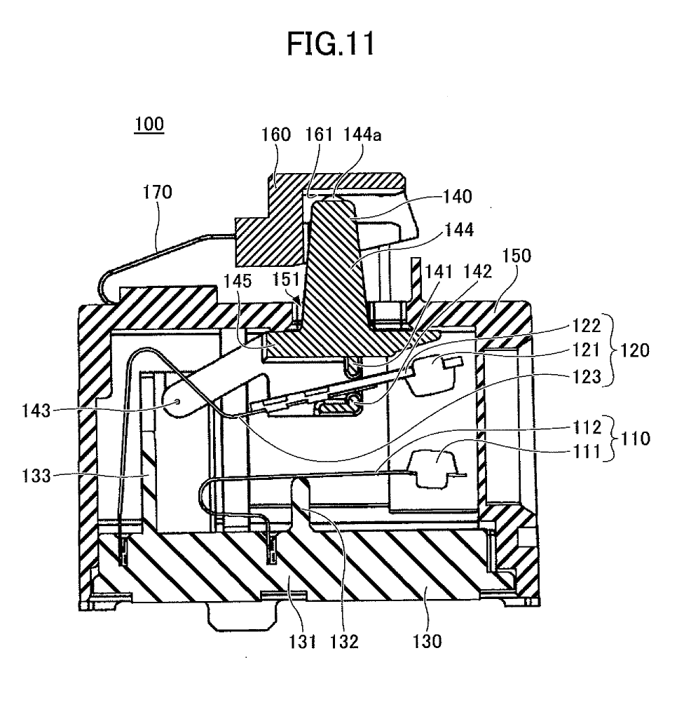

Next, the switch 100 is described. The switch 100 of the connector 10 according to this embodiment is a switch configured to switch the supply of electric power, and is also referred to as a power supply switch. FIG. 10 is a perspective view of the switch 100, and FIG. 11 is an internal structure diagram of the switch 100. As depicted in FIG. 11, the switch 100 can perform the on-off control of the supply of electric power by bringing a fixed contact 111 of a fixed part 110 into and out of contact with a movable contact 121 of a movable part 120.

The fixed part 110 is formed of an electrically conductive material, and has the fixed contact 111 provided at one end of a fixed spring 112. The fixed spring 112 is formed by bending a metal plate or the like formed of copper or an alloy containing copper, and the fixed contact 111 is formed of a silver-copper alloy. The other end of the fixed spring 112 is fixed to a base block body 131 of a base block 130, and an intermediate portion of the fixed spring 112 is supported by a support 132.

The movable part 120 is formed of an electrically conductive material. The movable contact 121 that contacts the fixed contact 111 is provided at one end of a movable plate 122, and the movable plate 122 and a movable spring 123 are connected. The movable plate 122 and the movable spring 123 are formed by bending a metal plate or the like formed of copper or an alloy containing copper, and the movable contact 121 is formed of a silver-copper alloy. The other end of the movable spring 123 is fixed to the base block body 131. The movable spring 123 is flexible, and can vertically move the movable contact 121. An insulating wall 133 formed of a flame-retardant resin material or the like is provided on the base block 130 between its portion to which the fixed spring 112 is fixed and its portion to which the movable spring 123 is fixed. The movable spring 123 is shaped to be bent around the insulating wall 133.

An upper surface of the movable plate 122 contacts a contact part 141 of a card 140, and a lower surface of the movable plate 122 contacts a contact part 142 of the card 140. By pivoting the card 140 about a pivot shaft 143 in the state of FIG. 11, the movable plate 122 contacts the contact part 141 or the contact part 142, so that a force is applied to the movable plate 122 to make it possible to vertically move the movable contact 121. The movable plate 122 slides on the contact part 141 and the contact part 142. Therefore, to reduce frictional resistance against the movable plate 122, a surface layer formed of fluororesin or the like may be provided on a surface of the contact part 141 and the contact part 142.

The fixed part 110 and the movable part 120 are installed within a region enclosed by the base block 130 and a case 150. The card 140 includes a projection 144 projecting outward through an opening 151 provided in the case 150 and a card body 145 positioned within the region enclosed by the base block 130 and the case 150. The contact part 141 and the contact part 142 as well are provided within the region enclosed by the base block 130 and the case 150. The card 140, the base block 130, and the case 150 are formed of an insulating material such as a resin material.

The button 160 to be depressed to pivot the card 140 is provided outside the case 150. The card 140 has a contact part 144a, provided on top of the projection 144, contacting an inner wall 161 of the button 160. The contact part 144a slides on a surface of the inner wall 161. Therefore, to reduce frictional resistance between the contact part 144a and the inner wall 161, a surface layer formed of fluororesin or the like may be provided on the surface of the inner wall 161. Furthermore, a separating spring 170, having one end connected to the case 150 and the other end connected to the button 160, is provided outside the case 150. The spring force of the separating spring 170 returns the button 160 upward when moving the slide 40 in the leftward direction of the arrow A of FIG. 9. The button 160 returns upward to move the card 140 upward.

### (On-Off Operation in Switch)

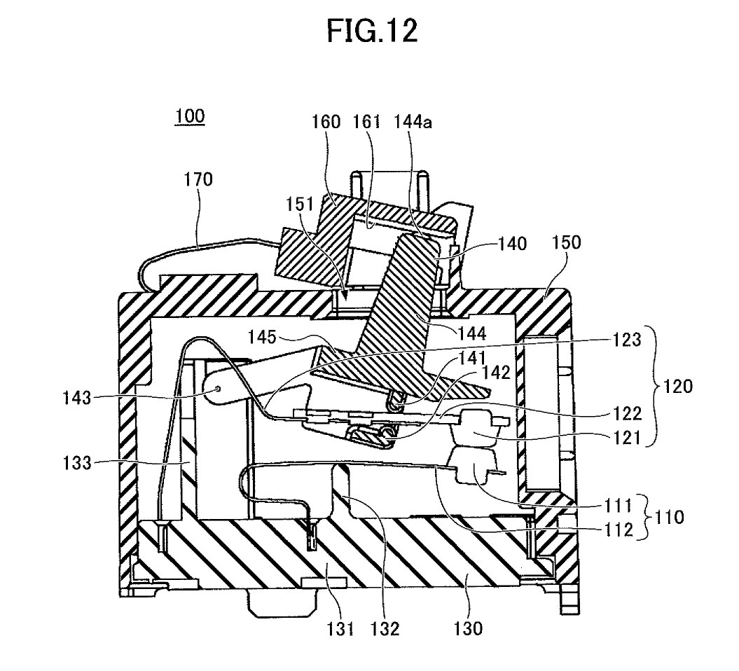

To turn on the switch 100, the contact slide 42 is slid in one direction, which is the rightward direction in the case of FIG. 9. As a result, the contact part 42b slides to depress the button 160, so that the card 140 having the contact part 144a contacting the inner wall 161 of the button 160 pivots about the pivot shaft 143 in the clockwise direction in FIG. 11. As a result, a downward force is applied to the movable plate 122 contacting the contact part 141 to move the movable contact 121 downward, so that the movable contact 121 and the fixed contact 111 come into contact to make it possible to supply electric power. FIG. 12 depicts the state where the movable contact 121 and the fixed contact 111 are in contact. Because the button 160 is kept in the position as depicted in FIG. 12 by the contact part 42b of the contact slide 42, the movable contact 121 and the fixed contact 111 are kept in contact.

To turn off the switch, as described below, the contact slide 42 is slid in a direction opposite to that at the time of turning on the switch, namely, the leftward direction in FIG. 9. When the contact part 42b moves to release the button, the spring force of the separating spring 170 moves the button 160 upward. As the button 160 moves upward, the card 140 is pulled up by the button 160 to pivot about the pivot shaft 143, so that an upward force is applied to the movable plate 122 contacting the contact part 142. A catching part 146 provided at the top of the card 140 as depicted in FIG. 20 catches in the button 160. Therefore, the card 140 is pulled up by the upward movement of the button 160. The movable contact 121 is thus moved upward by the upward force applied to the movable plate 122 to make it possible to separate the movable contact 121 and the fixed contact 111 as illustrated in FIG. 11 and to stop supplying electric power. At this point, an arc may be generated between the movable contact 121 and the fixed contact 111. Therefore, to make it possible to blow off an arc with a magnetic force, a non-depicted permanent magnet that produces a magnetic field in a direction substantially perpendicular to the direction of generation of an arc is provided near the contact position of the movable contact 121 and the fixed contact 111.

When interrupting the supply of electric power in the switch 100, the movable contact 121 is not moved upward using the spring force of the movable spring 123, but the button 160 is pressed upward by the separating spring 170 provided outside the case 150 to move the card 140 upward to turn off the switch 100. Therefore, even when the movable spring 123 does not have enough force to separate the movable contact 121 from the fixed contact 111, the switch can be turned off. Furthermore, even if the movable spring 123 is partly melted by heat to lose a function as a spring, it is possible to turn off the switch with the springiness of the separating spring 170 without using the spring force of the movable spring 123 to ensure the interruption of the supply of electric power. Furthermore, the separating spring 170, which is installed outside the case 150, is not affected by heat generated inside the case 150.

Furthermore, the insulating wall 133 is provided between a portion of the base block 130 to which the fixed spring 112 is fixed and a portion of the base block 130 to which the movable spring 123 is fixed. Even if the melting of the fixed part 110 and the movable part 120 progresses, the molten portion of the fixed part 110 and the molten portion of the movable part 120 are separated by the insulating wall 133. Accordingly, it is possible to prevent the fixed part 110 and the movable part 120 from melting and remaining stuck together and causing an electric current to keep flowing.

### (On-Off Operation in Connector)

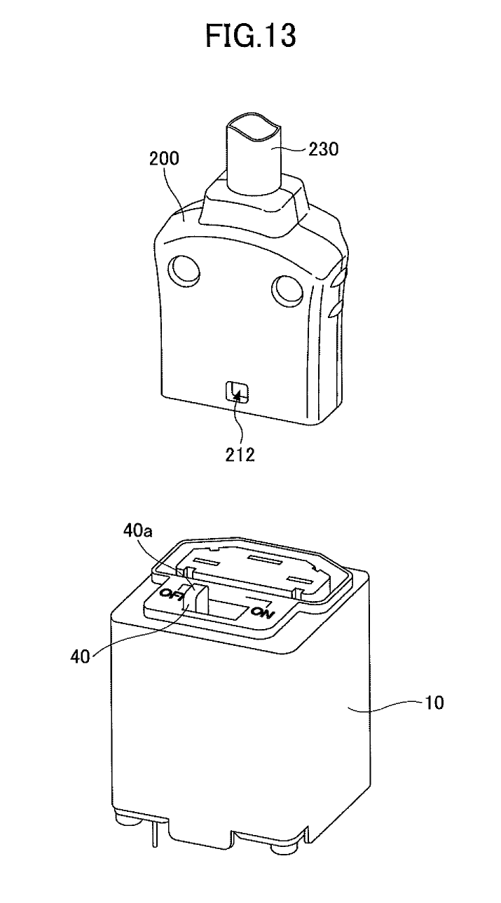

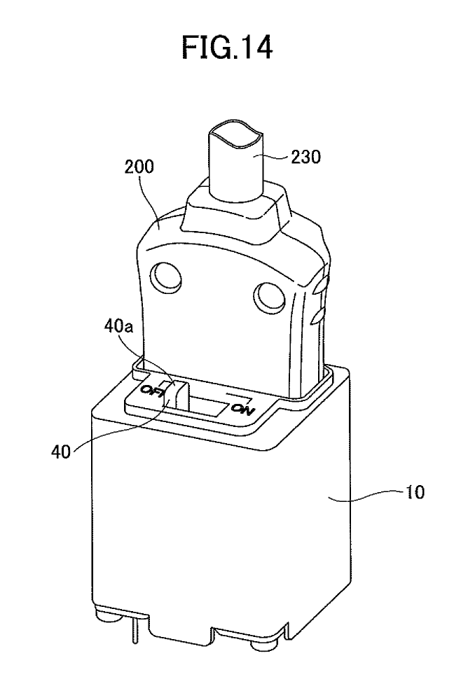

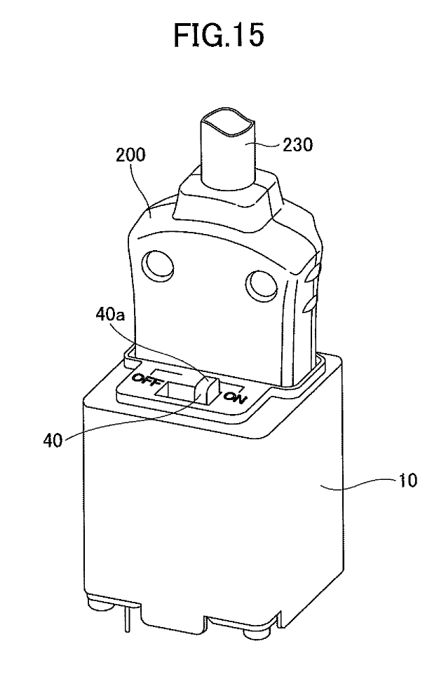

Next, the on-off operation of the connector 10 according to this embodiment is described. The connector 10 and the plug connector 200 separated as depicted in FIG. 13 are mated together as depicted in FIG. 14. Then, by switching the on and off of the connector 10 in the state of FIG. 14, it is possible to turn on or off the switch 100. Specifically, the operation part 40a of the slide 40 is slid from the “OFF” position depicted in FIG. 14 to the “ON” position depicted in FIG. 15. Sliding the slide 40 causes the contact part 42b to press an upper step 165 at the upper surface of the button 160 to move the button 160 downward, so that the switch 100 switches from the off-state depicted in FIG. 9 to the on-state depicted in FIG. 16. In the case of turning the switch 100 from on to off, the operation part 40a is slid from the “ON” side depicted in FIG. 15 to the “OFF” side depicted in FIG. 14.

When the switch 100 turns on, a non-depicted hook provided in the connector 10 enters the opening 212 of the plug connector 200 depicted in FIG. 4. The entry of the hook maintains the mating of the connector 10 and the plug connector 200, thus making it possible to prevent the plug connector 200 from coming off. When the switch 100 turns off, the hook disengages from the opening 212 to allow the plug connector 200 to be disconnected from the connector 10.

### (Twin-contact Switch)

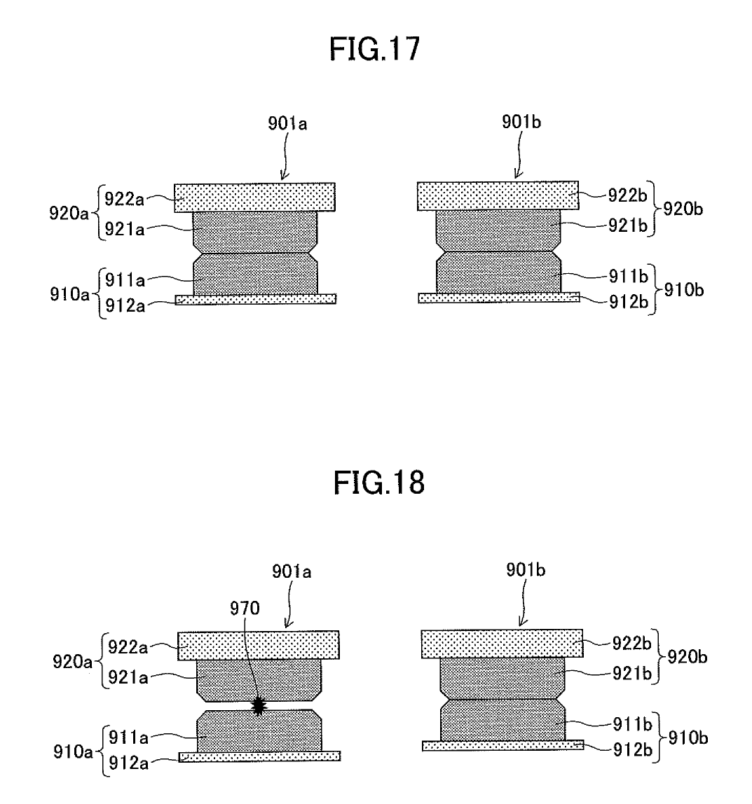

The switch of the connector 10 may be provided with two of each of the fixed part and the movable part that form the switch. In the illustration of FIG. 17, two pairs of a first fixed part 910a and a second fixed part 910b and a first movable part 920a and a second movable part 920b are provided.

The first fixed part 910a includes a first fixed contact 911a and a first fixed spring 912a, and the second fixed part 910b includes a second fixed contact 911b and a second fixed spring 912b. The first movable part 920a includes a first movable contact 921a and a first movable plate 922a, and the second movable part 920b includes a second movable contact 921b and a second movable plate 922b.

The first fixed part 910a and the first movable part 920a form a first switch 901a, and the second fixed part 910b and the second movable part 920b form a second switch 901b. The switch illustrated in FIG. 17 turns on when both of the first switch 901a and the second switch 901b turn on, and turns off when one of the first switch 901a and the second switch 901b turns off. The first switch 901a turns on when the first fixed contact 911a comes into contact with the first movable contact 921a, and turns off when the first fixed contact 911a is separated from the first movable contact 921a. Likewise, the second switch 901b turns on when the second fixed contact 911b comes into contact with the second movable contact 921b, and turns off when the second fixed contact 911b is separated from the second movable contact 921b.

According to the switch thus structured, if there is a foreign object 970 between the first fixed contact 911a and the first movable contact 921a or between the second fixed contact 911b and the second movable contact 921b as illustrated in FIG. 18, the electrical conduction between the fixed contact and the movable contact is interrupted to prevent the switch from turning on. Therefore, electric power cannot be supplied.

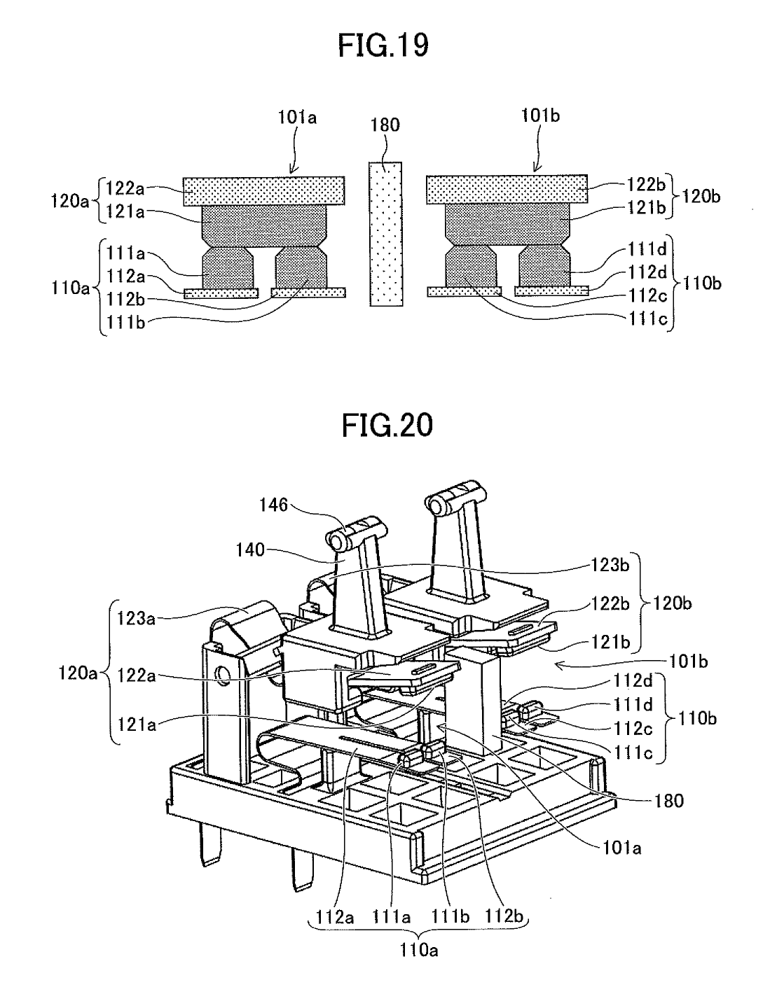

Next, the switch 100 according to this embodiment is described. The fixed part or movable part of a first switch 101a and a second switch 101b of the switch 100 is formed of a twin contact. In the illustration of FIGS. 19 and 20, a first fixed part 110a and a second fixed part 110b are twin contacts.

The first fixed part 110a includes two fixed contacts, namely, a first fixed contact 111a and a second fixed contact 111b. The first fixed contact 111a is installed on a first fixed spring 112a, and the second fixed contact 111b is installed on a second fixed spring 112b. The second fixed part 110b includes two fixed contacts, namely, a third fixed contact 111c and a fourth fixed contact 111d. The third fixed contact 111c is installed on a third fixed spring 112c, and the fourth fixed contact 111d is installed on a fourth fixed spring 112d.

As illustrated in FIG. 20, the first fixed spring 112a and the second fixed spring 112b are electrically connected, and a groove is formed in a one-piece fixed spring to separate the first fixed spring 112a and the second fixed spring 112b. Likewise, a groove is formed in a one-piece fixed spring to separately form the third fixed spring 112c and the fourth fixed spring 112d.

A first movable part 120a includes a single first movable contact 121a. The first movable contact 121a is installed on a first movable plate 122a, and the first movable plate 122a is connected to a first movable spring 123a. Likewise, a second movable part 120b includes a single second movable contact 121b. The second movable contact 121b is installed on a second movable plate 122b, and the second movable plate 122b is connected to a second movable spring 123b.

According to this embodiment, the first fixed part 110a and the first movable part 120a form the first switch 101a. The second fixed part 11b and the second movable part 120b form the second switch 101b.

The switch 100 turns on when both of the first switch 101a and the second switch 101b turn on, and turns off when one of the first switch 101a and the second switch 101b turns off.

The first switch 101a is a twin-contact switch. Therefore, when at least one of the first fixed contact 111a and the second fixed contact 111b contacts the first movable contact 121a, the first switch 101a turns on. Likewise, the second switch 101b as well is a twin-contact switch. Therefore, when at least one of the third fixed contact 111c and the fourth fixed contact 111d contacts the second movable contact 121b, the second switch 101b turns on.

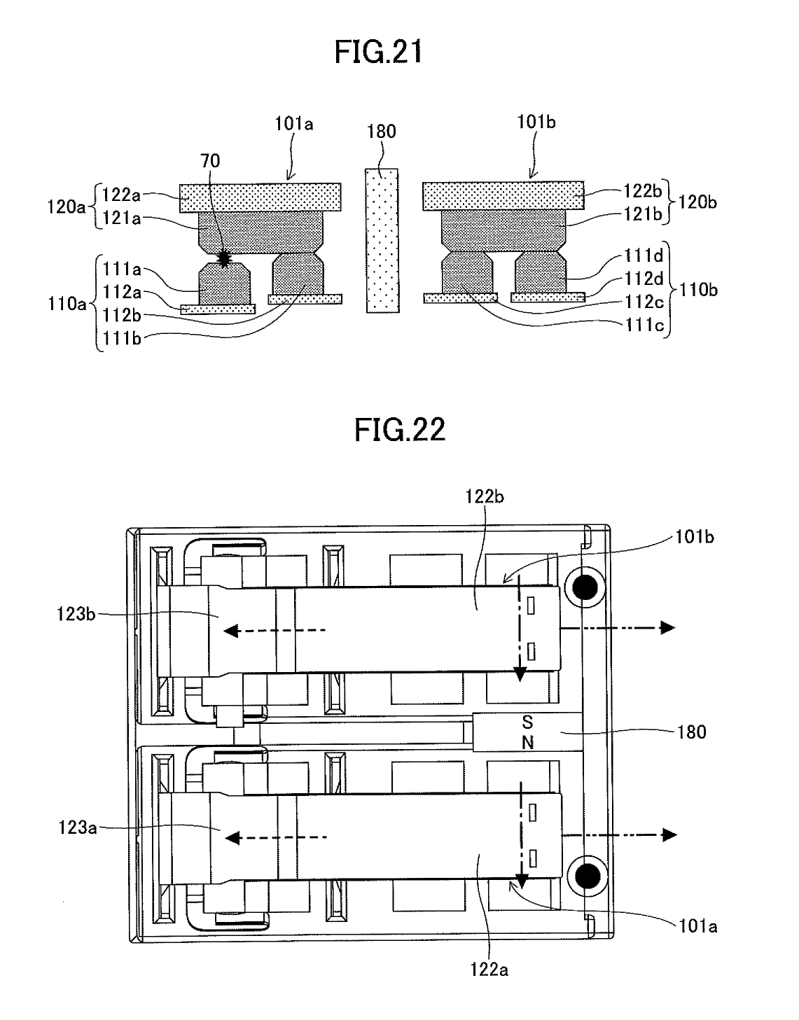

Accordingly, as illustrated in FIG. 21, even if there is a foreign object 70 between the first fixed contact 111a and the first movable contact 121a, the first switch 101a turns on if the second fixed contact 111b and the first movable contact 121a are in contact, and the switch 100 can be turned on when the second switch 101b as well turns on.

According to this embodiment, a permanent magnet 180 is installed between the first switch 101a and the second switch 101b. By installing the permanent magnet 180 between the first switch 101a and the second switch 101b, an arc generated between a fixed contact and a movable contact can be blown off by the magnetic field produced by the permanent magnet 180. For example, as illustrated in FIG. 22, the permanent magnet 180 installed between the first switch 101a and the second switch 101b produces a magnetic field in the direction indicated by the one-dot chain arrows. Therefore, an arc generated between contacts can be blown off in the direction indicated by the two-dot chain arrows by an electric current flowing in the direction indicated by the dashed arrows.

In the case of the switch depicted in FIG. 17, the first switch 101a and the second switch 101b do not always turn on simultaneously, and of the first switch 901a and the second switch 901b, one switch may turn on first and the other switch may turn on afterward. In this case, the switch that turns on afterward turns on to turn on the switch. Accordingly, an arc due to an inrush current caused by chattering or the like may be generated between the contacts of the switch that turns on afterward to damage a contact surface of the switch that turns on afterward, causing a conduction failure.

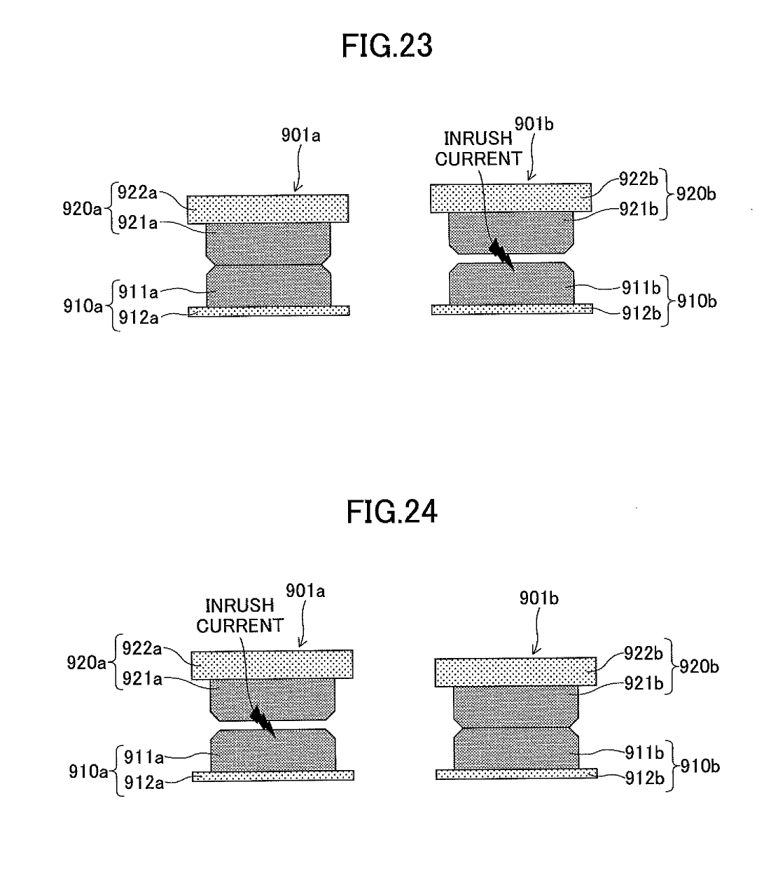

In the case of the switch depicted in FIG. 17, there are two possible cases, namely, the case where the first switch 901a turns on first and the second switch 901b turns on afterward as illustrated in FIG. 23 and the case where the second switch 901b turns on first and the first switch 901a turns on afterward as illustrated in FIG. 24. Therefore, at the time of a single on-operation, the probability that an inrush current flows between the first fixed contact 911a and the first movable contact 921a and the probability that an inrush current flows between the second fixed contact 111b and the second movable contact 921b are believed to be approximately ½ each.

In contrast, four fixed contacts, namely, the first fixed contact 111a, the second fixed contact 111b, the third fixed contact 111c, and the fourth fixed contact 111d, are provided in the switch 100 according to this embodiment. According to the switch 100, an inrush current occurs between a fixed contact that contacts first and a movable contact among the contacts of one of the first switch 101a and the second switch 101b that turns on afterward.

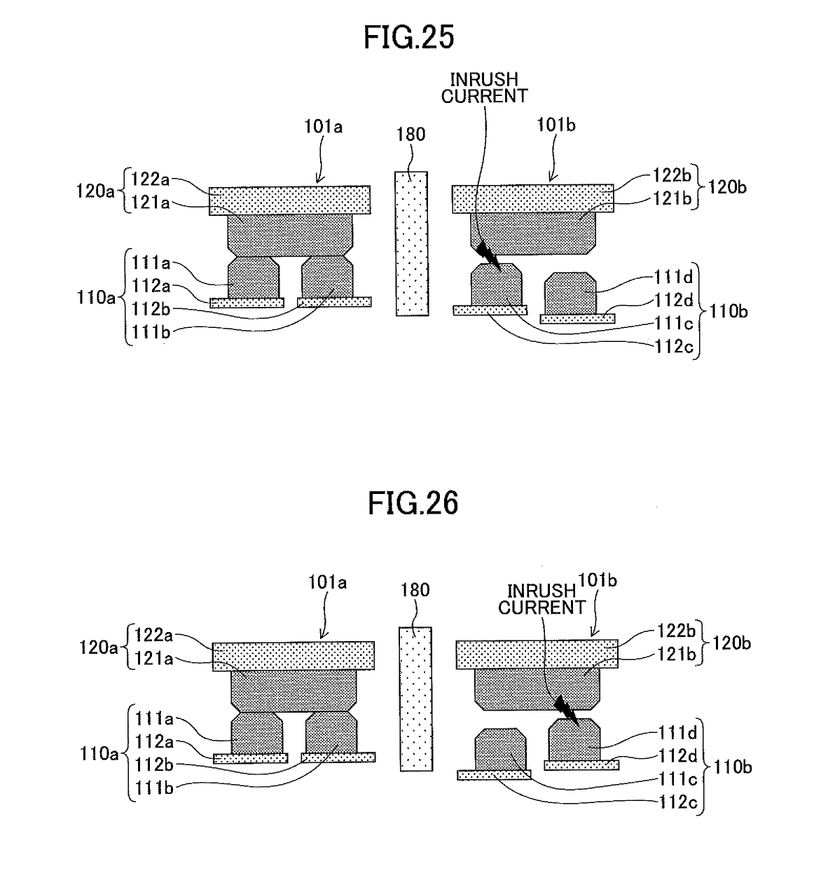

As illustrated in FIG. 25, with at least one of the first fixed contact 111a and the second fixed contact 111b contacting the first movable contact 121a, an inrush current flows between the third fixed contact 111c and the second movable contact 121b when the third fixed contact 111c contacts the second movable contact 121b before the fourth fixed contact 111d.

Alternatively, as illustrated in FIG. 26, with at least one of the first fixed contact 111a and the second fixed contact 111b contacting the first movable contact 121a, an inrush current flows between the fourth fixed contact 111d and the second movable contact 121b when the fourth fixed contact 111d contacts the second movable contact 121b before the third fixed contact 111c.

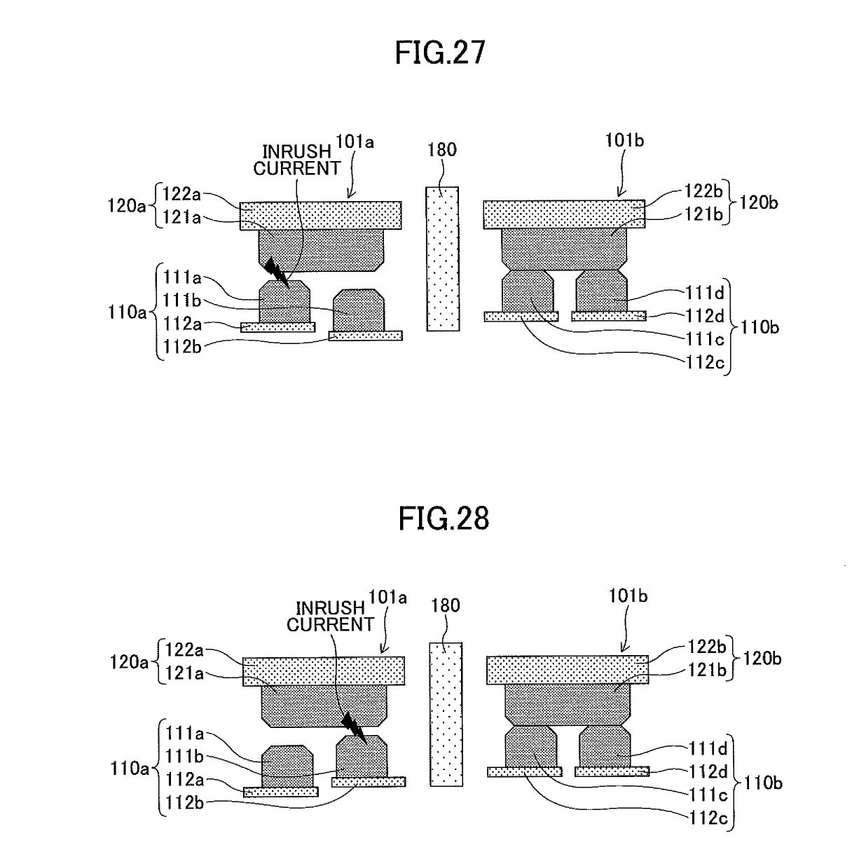

Alternatively, as illustrated in FIG. 27, with at least one of the third fixed contact 111c and the fourth fixed contact 111d contacting the second movable contact 121b, an inrush current flows between the first fixed contact 111a and the first movable contact 121a when the first fixed contact 111a contacts the first movable contact 121a before the second fixed contact 111b.

Alternatively, as illustrated in FIG. 28, with at least one of the third fixed contact 111c and the fourth fixed contact 111d contacting the second movable contact 121b, an inrush current flows between the second fixed contact 111b and the first movable contact 121a when the second fixed contact 111b contacts the first movable contact 121a before the first fixed contact 111a.

Accordingly, in a single on-operation, the probability of an inrush current flowing through each fixed contact is believed to be ¼. Thus, according to this embodiment, the probability of an inrush current flowing through each fixed contact is reduced by half in comparison with the case illustrated in FIG. 17. Therefore, even with the same number of times of turning on, it is possible to reduce damage caused to each fixed contact and to extend the service life of the connector.

The above case describes an arc due to an inrush current that occurs when a switch turns from off to on. The same is the case with an arc generated when a switch turns from on to off.

When a switch turns from on to off, an arc is generated between a fixed contact that separates afterward and a movable contact among the contacts of one of the first switch 101a and the second switch 101b that turns off first in the switch 100.

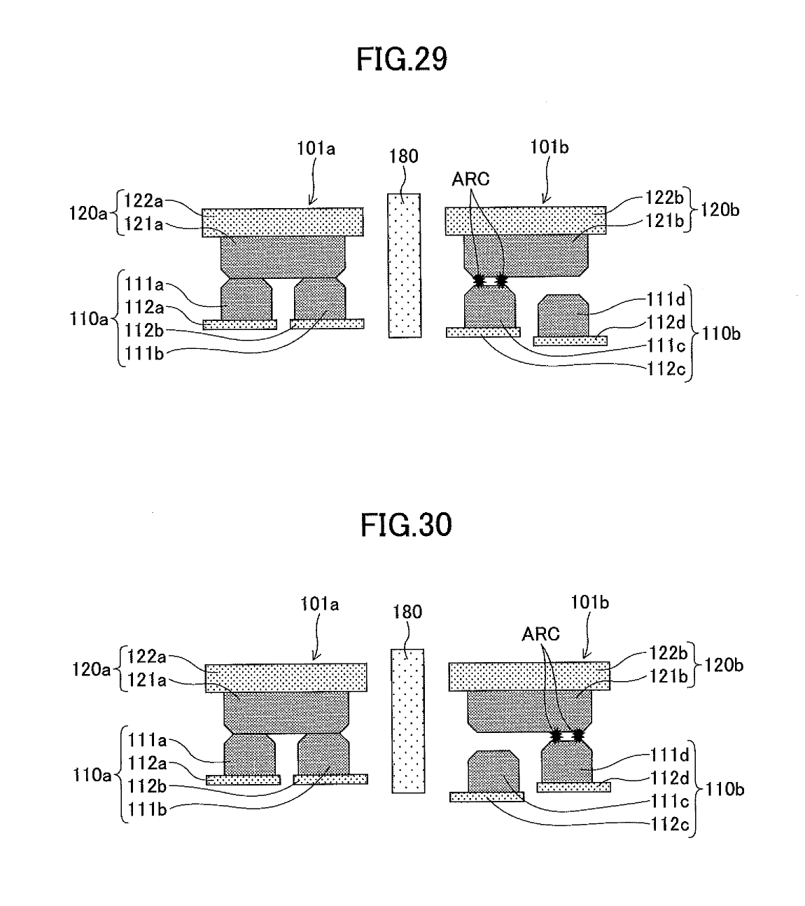

Specifically, as illustrated in FIG. 29, with at least one of the first fixed contact 111a and the second fixed contact 111b contacting the first movable contact 121a, an arc is generated between the third fixed contact 111c and the second movable contact 121b when the third fixed contact 111c separates from the second movable contact 121b after the fourth fixed contact 111d.

Alternatively, as illustrated in FIG. 30, with at least one of the first fixed contact 111a and the second fixed contact 111b contacting the first movable contact 121a, an arc is generated between the fourth fixed contact 111d and the second movable contact 121b when the fourth fixed contact 111d separates from the second movable contact 121b after the third fixed contact 111c.

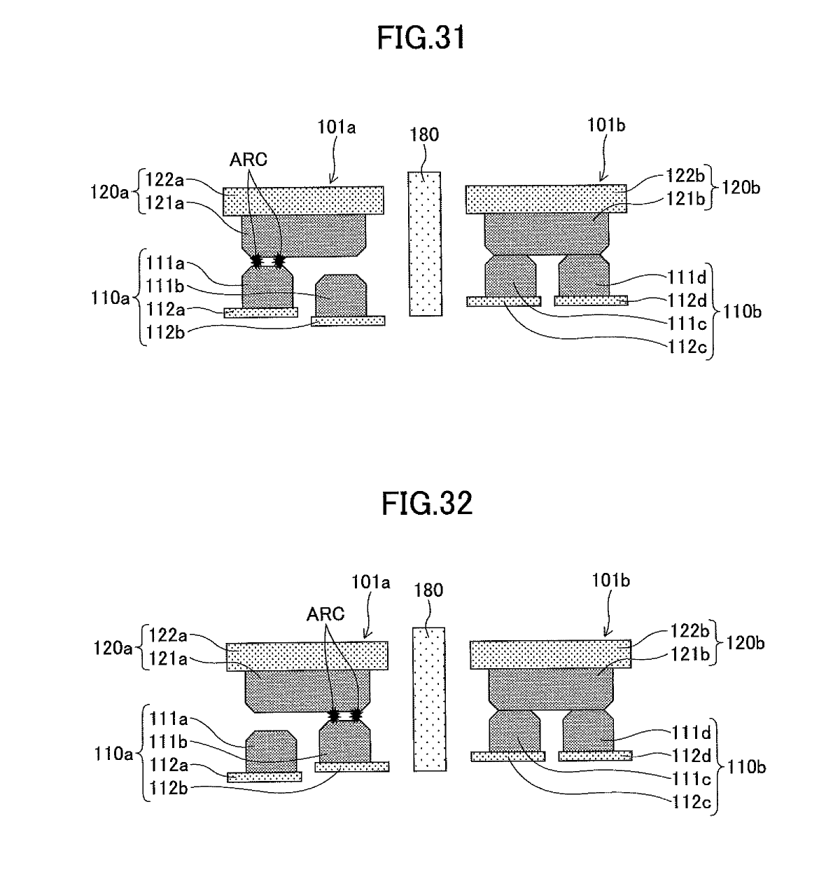

Alternatively, as illustrated in FIG. 31, with at least one of the third fixed contact 111c and the fourth fixed contact 111d contacting the second movable contact 121b, an arc is generated between the first fixed contact 111a and the first movable contact 121a when the first fixed contact 111a separates from the first movable contact 121a after the second fixed contact 111b.

Alternatively, as illustrated in FIG. 32, with at least one of the third fixed contact 111c and the fourth fixed contact 111d contacting the second movable contact 121b, an arc is generated between the second fixed contact 111b and the first movable contact 121a when the second fixed contact 111b separates from the first movable contact 121a after the first fixed contact 111a.

Accordingly, at the time of a single off-operation, the probability of generation of an arc at each fixed contact is ¼. Thus, the probability of generation of an arc at each fixed contact is reduced by half in comparison with the case illustrated in FIG. 17. Therefore, even with the same number of times of turning off, it is possible to reduce damage caused to each fixed contact and to extend the service life of the connector.

### Second Embodiment

Next, a second embodiment is described. This embodiment is a structure where multiple movable contacts are provided in a single switch.

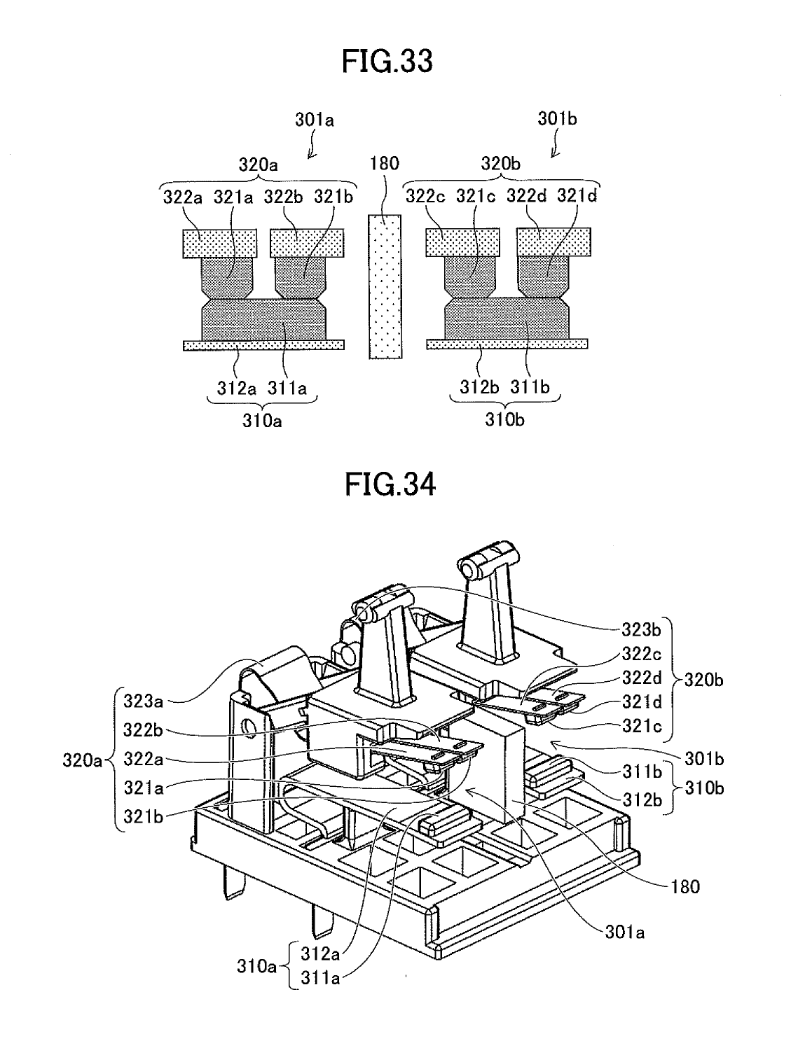

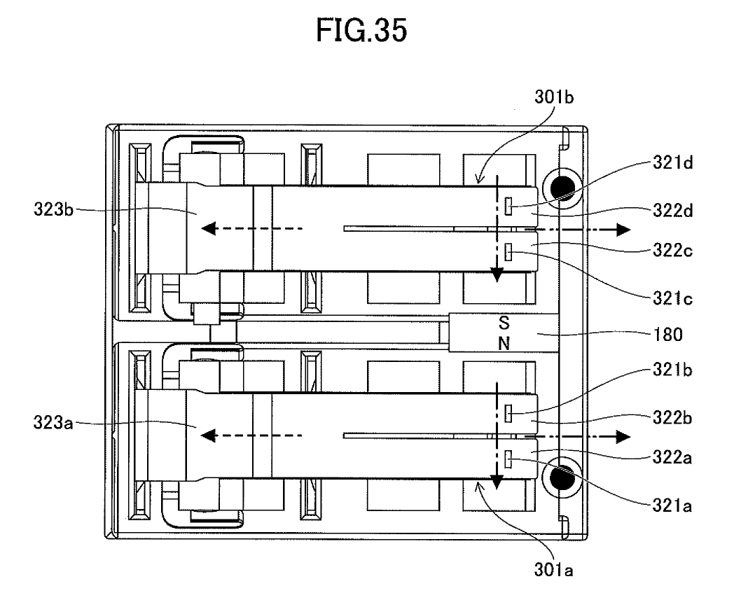

A switch according to this embodiment depicted in FIG. 33 includes a first switch 301a and a second switch 301b each including a movable part formed of a twin contact. As depicted in FIGS. 34 and 35, a first fixed part 310a and a second fixed part 310b, and a first movable part 320a and a second movable part 320b are provided in the switch.

The first fixed part 310a includes a first fixed contact 311a installed on a first fixed spring 312a. The second fixed part 310b includes a second fixed contact 311b installed on a second fixed spring 312b.

The first movable part 320a includes a first movable contact 321a and a second movable contact 321b. The first movable contact 321a is installed on a first movable plate 322a, and the second movable contact 321b is installed on a second movable plate 322b. The first movable plate 322a and the second movable plate 322b are connected to a first movable spring 323a.

The second movable part 320b includes a third movable contact 321c and a fourth movable contact 321d. The third movable contact 321c is installed on a third movable plate 322c, and the fourth movable contact 321d is installed on a fourth movable plate 322d. The third movable plate 322c and the fourth movable plate 322d are connected to a second movable spring 323b.

According to this embodiment, the first fixed part 310a and the first movable part 320a form the first switch 301a. The second fixed part 310b and the second movable part 320b form the second switch 301b.

The first switch 301a is a twin-contact switch, and turns on when the first fixed contact 311a contacts at least one of the first movable contact 321a and the second movable contact 321b and turns off when the first fixed contact 311a separates from both of the first movable contact 321a and the second movable contact 321b. Likewise, the second switch 301b as well is a twin-contact switch, and turns on when the second fixed contact 311b contacts at least one of the third movable contact 321c and the fourth movable contact 321d and turns off when the second fixed contact 311b separates from both of the third movable contact 321c and the fourth movable contact 321d.

According to this embodiment, the permanent magnet 180 is installed between the first switch 301a and the second switch 301b. An arc generated between a fixed contact and a movable contact can be blown off by the magnetic field of the permanent magnet 180. For example, as illustrated in FIG. 35, the permanent magnet 180 installed between the first switch 301a and the second switch 301b produces a magnetic field in the direction indicated by the one-dot chain arrows, so that an arc generated between contacts can be blown off in the direction indicated by the two-dot chain arrows by an electric current flowing in the direction indicated by the dashed arrows.

The contents other than those described above are the same as in the first embodiment.

Embodiments of the present invention are described above, but the above description does not limit the subject matter of the present invention.

The present international application is based upon and claims priority to Japanese Patent Application No. 2015-022619, filed on Feb. 6, 2015, the entire contents of which are incorporated herein by reference.

### DESCRIPTION OF THE REFERENCE NUMERALS

10 connector

21, 22, 23 jack opening

40a operation part

41 slide link

42 contact slide

101a first switch

101b second switch

110 fixed part

110a first fixed part

110b second fixed part

111 fixed contact

111a first fixed contact

111b second fixed contact

111c third fixed contact

111d fourth fixed contact

112 fixed spring

112a first fixed spring

112b second fixed spring

112c third fixed spring

112d fourth fixed spring

120 movable part

120a first movable part

120b second movable part

121 movable contact

121a first movable contact

121b second movable contact

122 movable plate

122a first movable plate

122b second movable plate

123 movable spring

123a first movable spring

123b second movable spring

130 base block

140 card

143 pivot shaft

144 projection

160 button

170 separating spring

180 permanent magnet

200 plug connector

221, 222, 223 plug terminal

1. A connector including two connection terminals to be electrically connected to terminals of another connector, and a switch connected to the connection terminals, wherein:
the switch includes
a first switch connected to one of the connection terminals, the first switch including a first fixed part including a fixed contact, and a first movable part including a movable contact that is contactable by the fixed contact; and
a second switch connected to another of the connection terminals, the second switch including a second fixed part including a fixed contact, and a second movable part including a movable contact that is contactable by the fixed contact,
wherein the first fixed part and the second fixed part, or the first movable part and the second movable part include a plurality of contacts.

2. The connector as claimed in claim 1, wherein
the first fixed part includes a first fixed contact and a second fixed contact, and
the second fixed part includes a third fixed contact and a fourth fixed contact.

3. The connector as claimed in claim 1, wherein
the first movable part includes a first movable contact and a second movable contact, and
the second movable part includes a third movable contact and a fourth movable contact.

4. A connector including a connection terminal to be electrically connected to a terminal of another connector, and a switch connected to the connection terminal, wherein:
the switch includes a fixed part including a fixed contact, and a movable part including a movable contact contactable by the fixed contact, and
a first fixed contact and a second fixed contact that are electrically interconnected are provided in the fixed part.

5. A connector including a connection terminal to be electrically connected to a terminal of another connector, and a switch connected to the connection terminal, wherein:
the switch includes a fixed part including a fixed contact, and a movable part including a movable contact contactable by the fixed contact, and
a first movable contact and a second movable contact that are electrically interconnected are provided in the movable part.
